(19) United States
(12) Patent Application Publication
(10) Pub. No.: US 2013/0308015 A1
(43) Pub. Date: Nov. 21, 2013

(54) TRANSMITTING APPARATUS

(71) Applicant: CANON KABUSHIKI KAISHA, Tokyo (JP)

(72) Inventor: Hironori Aokage, Yashio-shi (JP)

(21) Appl. No.: 13/895,078

(22) Filed: May 15, 2013

(30) Foreign Application Priority Data
May 18, 2012 (JP) 2012-114615

(51) Int. Cl. H04N 5/76

(52) U.S. Cl. CPC H04N 5/76
USPC 348/231.99

(57) ABSTRACT

A transmitting apparatus includes a generating unit that generates image data, a storing unit that stores a file including image data generated by the generation unit in a storage medium in response to a recording instruction, a transmitting unit that transmits image data to a receiving apparatus, and a control unit that performs a process for transmitting, to the receiving apparatus, data for identifying a file relating to image data to be transmitted to the receiving apparatus.

### BACKGROUND OF THE INVENTION

1. Field of the Invention

The present invention relates to a transmitting apparatus for transmitting image data to the outside.

2. Description of the Related Art

A communication interface called High-Definition Multimedia Interface (HDMI) (registered trademark) has been proposed. An HDMI-compliant communication system includes a source apparatus and a sink apparatus. The source apparatus is capable of sending image data via an HDMI interface. The sink apparatus is capable of receiving image data from a source apparatus via an HDMI interface, and displaying the received image data on a display device.

Japanese Patent Application Laid-Open No. 2009-77347 discusses a source apparatus for acquiring Extended Display Identification Data (EDID) including information of resolution of a sink apparatus. The source apparatus generates data to be transmitted to the sink apparatus using the EDID acquired from the sink apparatus.

In such a communication system, when the source apparatus transmits image data to the sink apparatus, the source apparatus performs conversion process to convert image data recorded in the source apparatus into image data compatible with an HDMI-standard transmission method. In such a system, further, according to the HDMI-standard transmission method, the source apparatus transmits the image data generated by the conversion process to the sink apparatus. The sink apparatus that has received the image data from the source apparatus can view, record, edit, or manage the image data received according to the HDMI-standard transmission method from the source apparatus.

In such a case, however, the sink apparatus is not notified of data about the image data of the state before the conversion from the source apparatus. Consequently, it is inconvenient for users to manage the image data received from the source apparatus.

### SUMMARY OF THE INVENTION

According to an aspect of the present invention, at least one of the above-described drawbacks and disadvantages are overcome.

The present invention is directed to a transmitting apparatus and control method capable of, in a case where image data is transmitted to an external device, appropriately managing the image data with the external device by notifying the external device of data about the image data to be transmitted to the external device.

According to an aspect of the present invention, there is provided a transmitting apparatus including a generating unit that generates image data, a storing unit that stores a file including image data generated by the generating unit in a storage medium after a recording instruction is input to the transmitting apparatus, a transmitting unit that transmits image data to a receiving apparatus, and a control unit that performs a process for transmitting, to the receiving apparatus, data for identifying a file relating to image data to be transmitted to the receiving apparatus.

According to another aspect of the present invention, there is provided a method including generating image data, storing a file including generated image data in a storage medium in response to a recording instruction, transmitting image data to a receiving apparatus, and transmitting, to the receiving apparatus, data for identifying a file relating to image data to be transmitted to the receiving apparatus.

According to yet another aspect of the present invention, there is provided a non-transitory computer-readable storage medium that stores a program for causing a computer to execute a method including generating image data, storing a file including generated image data in a storing medium in response to a recording instruction, transmitting image data to a receiving apparatus, and transmitting, to the receiving apparatus, data for identifying a file relating to image data to be transmitted to the receiving apparatus.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a communication system according to a first exemplary embodiment.

FIG. 2 is a block diagram illustrating an example of an image transmission system according to the first exemplary embodiment.

FIG. 3 is a block diagram illustrating an example of a receiving apparatus according to the first exemplary embodiment.

FIGS. 4A and 4B illustrate an example of a first operation to be performed in a transmitting apparatus according to the first exemplary embodiment.

FIGS. 5A and 5B illustrate an example of a second operation to be performed in the transmitting apparatus according to the first exemplary embodiment.

FIGS. 6A and 6B are a flowchart illustrating an example of notification process to be performed in the transmitting apparatus according to the first exemplary embodiment.

### DESCRIPTION OF THE EMBODIMENTS

Various exemplary embodiments, features, and aspects of the invention will be described in detail below with reference to the drawings.

The exemplary embodiments described below are only examples, and the present invention is not limited to the exemplary embodiments.

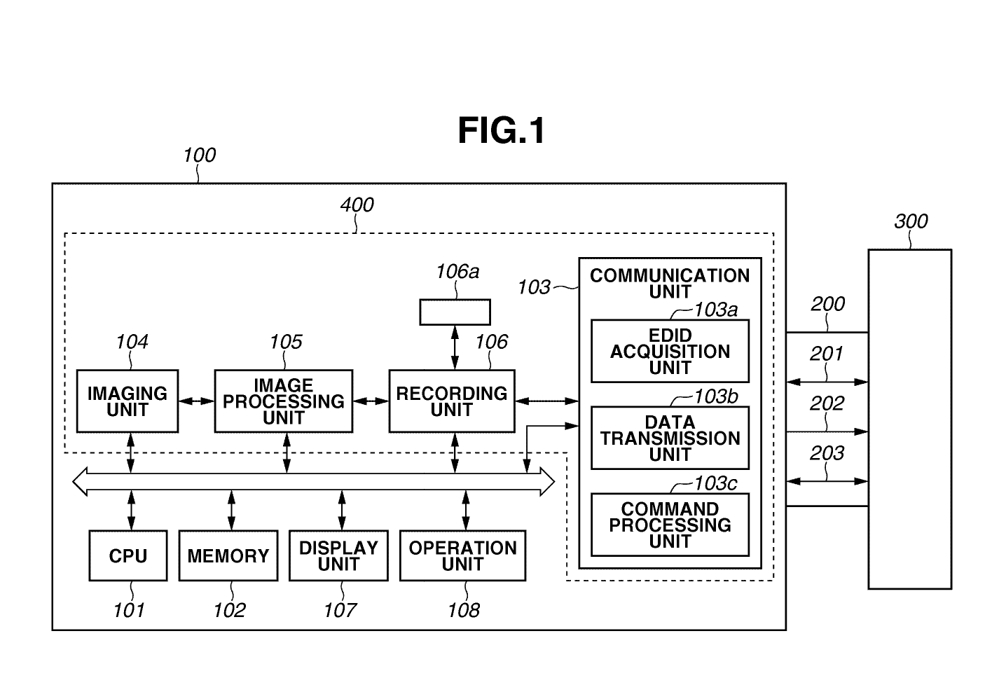

As illustrated in FIG. 1, in a communication system according to a first exemplary embodiment, a transmitting apparatus 100 and a receiving apparatus 300 are communicably connected with each other via a connection cable 200. The transmitting apparatus 100 and the receiving apparatus 300 in the communication system according to the first exemplary embodiment can perform communication complying with the HDMI standard. In the first exemplary embodiment, the connection cable 200 is an HDMI-compliant cable.

The connection cable 200 includes a power line (not illustrated), a Hot Plug Detect (HPD) line (not illustrated), and a Display Data Channel (DDC) line 201. The connection cable 200 further includes a Transition-Minimized Differential Signaling (TMDS) line 202, and a Consumer Electronics Control (CEC) line 203.

The transmitting apparatus 100 can be an imaging apparatus such as a digital single lens reflex camera, a digital still camera, and a digital video camera, or a communication apparatus such as a mobile phone or a smart phone. The transmitting apparatus 100 can be any electronic apparatus having a function to generate image data. The receiving apparatus 300 can be a display device such as a television set, a personal computer, and a projector, or a recording apparatus such as a recorder and a hard disk drive. The receiving apparatus 300 can be an electronic apparatus for receiving image data or audio data from the transmitting apparatus 100.

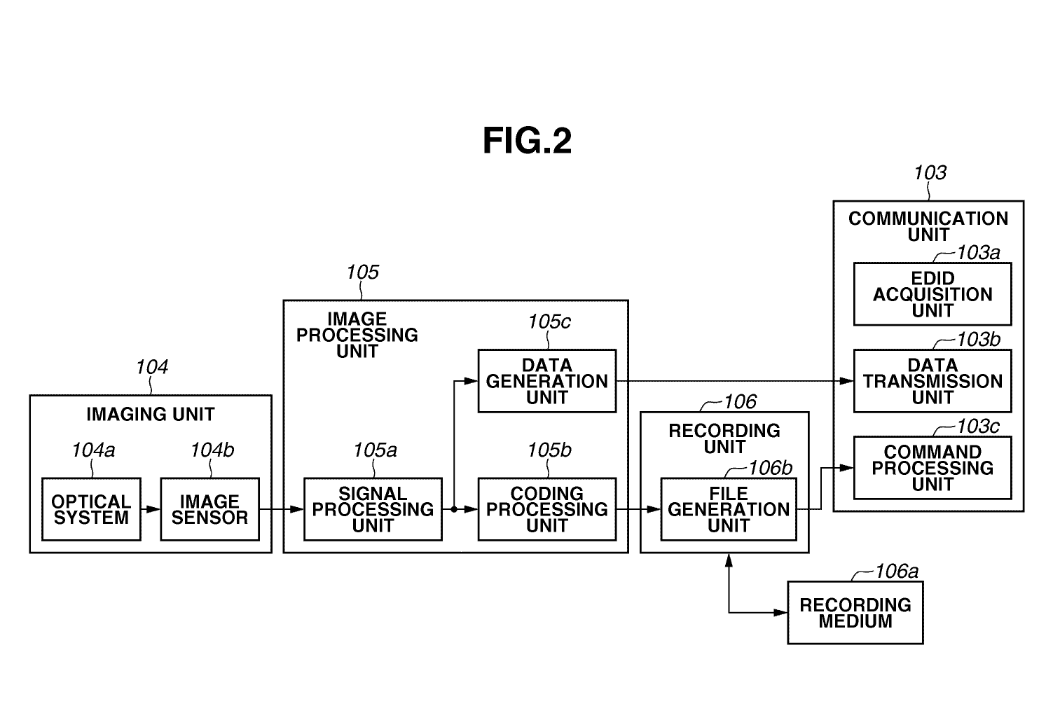

With reference to FIG. 1, the transmitting apparatus 100 is described. The transmitting apparatus 100 includes a central processing unit (CPU) 101, a memory 102, a communication unit 103, an imaging unit 104, an image processing unit 105, a recording unit 106, a display unit 107, and an operation unit 108. A system including the communication unit 103, the imaging unit 104, the image processing unit 105, and the recording unit 106 is referred to as an image transmission system 400. FIG. 2 illustrates a configuration of the image transmission system 400. The transmitting apparatus 100 has operation modes of a shooting mode and a reproduction mode.

The CPU 101 is a control unit for controlling operation of the transmitting apparatus 100 according to a computer program stored in the memory 102. The CPU 101 can determine an image display capability and an audio processing capability of the receiving apparatus 300 by analyzing device information of the receiving apparatus 300 acquired from the receiving apparatus 300. The device information of the receiving apparatus 300 is, for example, Extended Display Identification Data (EDID) or Enhanced EDID (E-EDID). Each of the EDID and the E-EDID includes, for example, information about identification information of the receiving apparatus 300, and resolutions, scanning frequencies, aspect ratios, and color spaces supported by the receiving apparatus 300. The E-EDID is an extension of the EDID, and includes more capability information than that of the EDID. For example, the E-EDID includes information about formats of video data and audio data supported by the receiving apparatus 300. Hereinafter, both the EDID and the E-EDID are referred to as “EDID”.

The transmitting apparatus 100 acquires EDID from the receiving apparatus 300 via a DDC line 201, and analyzes the EDID acquired via the DDC line 201. The transmitting apparatus 100 can determine, for example, an image display capability, and an audio processing capability of the receiving apparatus 300 from the analysis result of the EDID. Further, the transmitting apparatus 100 can generate video data and audio data appropriate to the image display capability and the audio processing capability of the receiving apparatus 300.

The memory 102 functions as a work area for the CPU 101. The memory 102 stores the EDID acquired from the receiving apparatus 300, the information about the transmitting apparatus 100, and the result of the analysis by the CPU 101. The work area of the CPU 101 is not limited to the memory 102, and alternatively, an external memory such as a hard disk drive can be employed.

The communication unit 103 includes a connection terminal (connector) for connecting the connection cable 200. The communication unit 103 further includes an EDID acquisition unit 103a, a data transmission unit 103b, and a command processing unit 103c.

The EDID acquisition unit 103a acquires EDID from the receiving apparatus 300 via the DDC line 201. The EDID acquired from the receiving apparatus 300 by the EDID acquisition unit 103a is supplied to the CPU 101.

The data transmission unit 103b transmits, via the TMDS line 202 to the receiving apparatus 300, video data appropriate to the image display capability of the receiving apparatus 300, audio data appropriate to the audio processing capability of the receiving apparatus 300 and additional data. The video data and the audio data to be transmitted to the receiving apparatus 300 by the data transmission unit 103b is generated based on the EDID acquired by the EDID acquisition unit 103a. The image data to be transmitted to the receiving apparatus 300 by the data transmission unit 103b may include at least one of still image data and moving image data.

The command processing unit 103c is capable of transmitting a command complying with the CEC protocol to the receiving apparatus 300 connected via the CEC line 203. Further, the command processing unit 103c is capable of receiving a command complying with the CEC protocol from the receiving apparatus 300 connected via the CEC line 203.

The command processing unit 103c is capable of supplying the command received from the receiving apparatus 300 to the CPU 101. The CPU 101 analyzes the command supplied from the command processing unit 103c, and based on the analysis result, controls the transmitting apparatus 100. The command to be transmitted to the receiving apparatus 300 is generated by the CPU 101.

FIG. 2 illustrates a configuration of the imaging unit 104. The imaging unit 104 includes an optical system 104a and an image sensor 104b. The imaging unit 104 performs photoelectric conversion of an optical image of an object entered via the optical system 104a with the image sensor 104b to generate analog data. The analog data generated by the imaging unit 104 is supplied to the image processing unit 105. The image sensor 104b includes, for example, a complementary metal-oxide semiconductor (CMOS) sensor or a charge coupled device (CCD) sensor.

FIG. 2 illustrates a configuration of the image processing unit 105. The image processing unit 105 includes a signal processing unit 105a, a coding processing unit 105b, and data generation unit 105c.

The image processing unit 105 controls the signal processing unit 105a so as to perform, on analog data supplied from the imaging unit 104, for example, process for converting the analog data into digital data, gain control process, and color interpolation process to generate image data.

The image data generated by the signal processing unit 105a is supplied to the coding processing unit 105b and the data generation unit 105c. The image data generated by the signal processing unit 105a is supplied to the recording unit 106 via the coding processing unit 105b. The image data generated by the signal processing unit 105a is supplied to the communication unit 103 via the data generation unit 105c.

The coding processing unit 105b performs coding process on the image data supplied from the signal processing unit 105a. The coding process includes, for example, process for encoding image data using adaptive discrete cosine transform (ADCT). The coding method for image data includes, for example, a Joint Photographic Experts Group (JPEG) method, a Motion Picture Experts Group (MPEG) method, and a RAW method. The image data coded by the coding process unit 105b is supplied to the recording unit 106.

The data generation unit 105c generates, from image data supplied from the signal processing unit 105a, image data to be supplied to the data transmission unit 103b by using EDID acquired by the EDID acquisition unit 103a. The data generation unit 105c performs process on the image data supplied from the signal processing unit 105a for converting the image data into image data appropriate to the display capability of the receiving apparatus 300 to generate image data to be supplied to the data transmission unit 103b. The generated image data is supplied from the data generation unit 105c to the data transmission unit 103b, and transmitted to the receiving apparatus 300.

The data transmission unit 103b, according to an instruction from the CPU 101, transmits the image data supplied from the data generation unit 105c to the receiving apparatus 300 via the TMDS line 202.

FIG. 2 illustrates a configuration of the recording unit 106. The recording unit 106 is, when being connected to the recording medium 106a, capable of recording data in the recording medium 106a. The recording unit 106 is, when being connected to the recording medium 106a, capable of reading data recorded in the recording medium 106a. The recording unit 106 is, when not being connected to the recording medium 106a, incapable of recording and reading data in and from the recording medium 106a. The recording medium 106a may be a recording apparatus provided in the transmitting apparatus 100, and alternatively may be an external recording apparatus attachable and detachable to and from the transmitting apparatus 100. Further, the recording medium 106a may be a memory card or a hard disk drive.

The recording unit 106 includes a file generation unit 106b. The recording unit 106 controls the file generation unit 106b to perform process for generating a file corresponding to the image data supplied from the coding processing unit 105b. The file generated by the file generation unit 106b includes image data encoded by the coding processing unit 105b and status data of the image data. The status data indicates settings in generating image data. For example, the status data includes data indicating a frame rate of each frame in the image data, data indicating a time code of each frame included in the image data, and data indicating a pixel range corresponding to the image data.

The file generation unit 106b adds a time code to each frame in the image data encoded by the coding processing unit 105b to generate a file. The recording unit 106 records the file generated by the file generation unit 106b in the recording medium 106a. The recording unit 106 is capable of supplying status data corresponding to the file generated by the file generation unit 106b to the communication unit 103.

While the transmitting apparatus 100 is in a shooting mode, when a user records desired image data, image data generated by the image processing unit 105 can be recorded in the recording medium 106a.

The display unit 107 includes a display device such as a liquid crystal display. While the transmitting apparatus 100 is in the shooting mode, the display unit 107 displays the image data generated by the imaging unit 104 and the image processing unit 105. While the transmitting apparatus 100 is in a reproduction mode, the display unit 107 displays the image data read from the recording medium 106a.

The operation unit 108 provides a user interface for operating the transmitting apparatus 100. The operation unit 108 includes buttons, switches, and a touch panel for operating the transmitting apparatus 100. The CPU 101 is capable of controlling the transmitting apparatus 100 according to instructions input by users via the operation unit 108. A user operates a button on the operation unit 108 to input an operation signal corresponding to the button to the CPU 101. The CPU 101 analyses the operation signal input via the operation unit 108, and based on the analysis result, determines process corresponding to the operation signal.

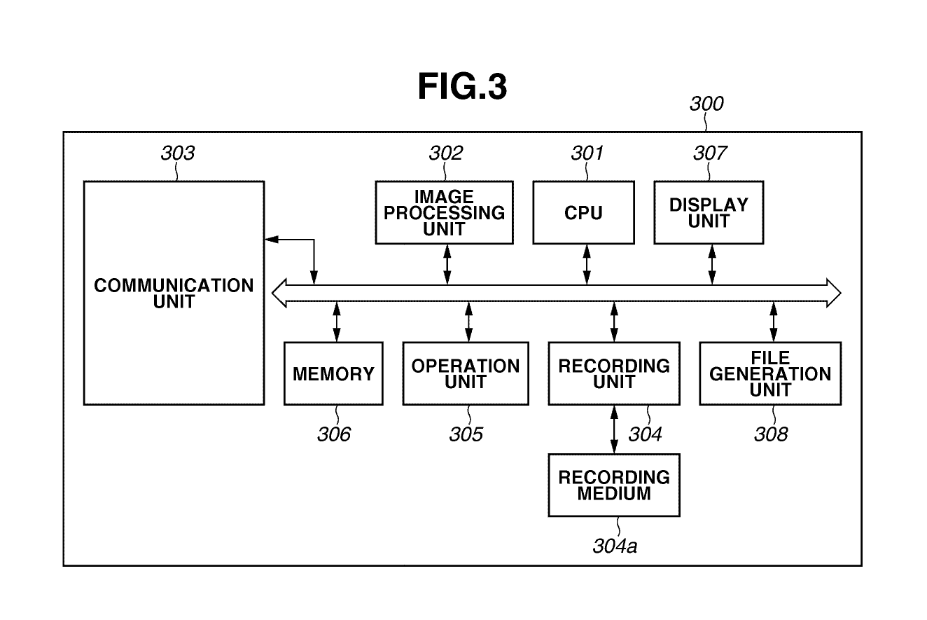

With reference to FIG. 3, the receiving apparatus 300 is described. The receiving apparatus 300 includes a CPU 301, an image processing unit 302, a communication unit 303, a recording unit 304, an operation unit 305, a memory 306, a display unit 307, and a file generation unit 308.

The CPU 301 controls operation of the receiving apparatus 300 according to a computer program stored in the memory 306.

The image processing unit 302 performs various kinds of image process on one of image data read from a recording medium 304a by the recording unit 304 and image data received from the transmitting apparatus 100 by the communication unit 303. The image data on which the image process has been performed by the image processing unit 302 is supplied at least one of the recording unit 304 and the display unit 307.

The communication unit 303 includes a connection terminal for connecting the connection cable 200. The communication unit 303 receives image data and additional data, transmitted from the transmitting apparatus 100, via the TMDS line 202. The image data received from the transmitting apparatus 100 by the communication unit 303 is supplied at least one of the image processing unit 302, the recording unit 304, the display unit 307, and the file generation unit 308. The additional data received from the transmitting apparatus 100 by the communication unit 303 is supplied to the file generation unit 308.

The recording unit 304 records image data supplied from the image processing unit 302 in the recording medium 304a. The recording unit 304 is also capable of supplying image data recorded in the recording medium 304a to at least one of the image processing unit 302 and the display unit 307. The recording medium 304a may be a memory provided in the receiving apparatus 300, and alternatively an external memory attachable and detachable to and from the receiving apparatus 300.

The operation unit 305 provides a user interface for operating the receiving apparatus 300.

The memory 306 functions as a work area for the CPU 301. The memory 102 stores EDID to be transmitted to the transmission unit 100 via the DDC line 201.

The display unit 307 displays the image data supplied from one of the communication unit 303, the image processing unit 302, and the recording unit 304.

The file generation unit 308 generates a file using the additional data and the image data supplied from the communication unit 303. The generated file is supplied to the recording unit 304 and recorded in the recording medium 304a.

When the file generation unit 308 generates a file including the image data received from the transmitting apparatus 100, the receiving apparatus 300 cannot specify, to the transmitting apparatus 100, a file name of the generated file according to specifications of a digital camera system. Consequently, in the receiving apparatus 300, if the generation of the file, including the image data received from the transmitting apparatus 100, is performed, the transmitting apparatus 100 is required to notify a file name corresponding to the file generated by the receiving apparatus 300.

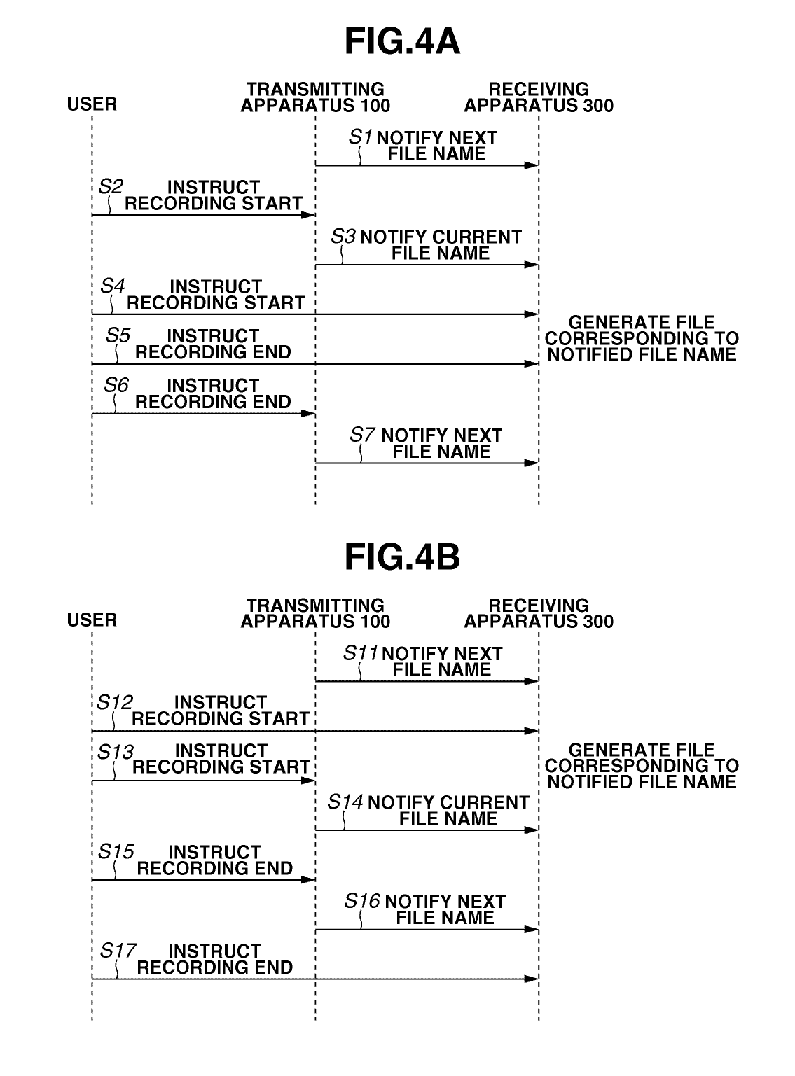

With reference of FIGS. 4A and 4B, in the notification of a file name from the transmitting apparatus 100 to the receiving apparatus 300, a first operation performed by the transmitting apparatus 100 is described. While the first operation is executed, the operation mode in the transmitting apparatus 100 is set to the shooting mode.

FIG. 4A illustrates an operation for using a file, generated based on image data transmitted from the transmitting apparatus 100, as a proxy image in the receiving apparatus 300 while using a file, recorded in the transmitting apparatus 100, as a main image. It is assumed that the file generated by the file generation unit 106b is recorded in the recording medium 106a.

The CPU 101 performs the process in step S1 when the data transmission unit 103b transmits image data to the receiving apparatus 300 via the TMDS line 202, and if image data generated by the imaging unit 104 and the image processing unit 105 is not recorded in the recording medium 106a. In step S1, the CPU 101 transmits a file name corresponding to a file to be recorded next by the transmitting apparatus 100 to the receiving apparatus 300. The file name corresponding to the file to be recorded by the transmitting apparatus 100 is referred to as “first file name”. Together with the first file name, status data of the image data to be transmitted to the receiving apparatus 300 may be transmitted to the receiving apparatus 300.

In step S2, a user inputs an operation signal for starting recording to the transmitting apparatus 100 via the operation unit 108. In this case, the CPU 101 controls the file generation unit 106b to generate a file including image data to be generated by the imaging unit 104 and the image processing unit 105. Further, in this case, the CPU 101 controls the recording unit 106 to record the generated file in the recording medium 106a. In step S3, the CPU 101 transmits, to the receiving apparatus 300, a file name corresponding to the file to be recorded in the recording medium 106a. The file name corresponding to the file to be recorded in the recording medium 106a is referred to as “second file name”. Together with the second file name, status data of the image data to be transmitted to the receiving apparatus 300 may be transmitted to the receiving apparatus 300.

In step S4, an operation signal for starting recording of image data is input by the user via the operation unit 305 to the receiving apparatus 300. In this case, the CPU 301 controls the file generation unit 308 to generate, using the image data received by the communication unit 303 from the transmitting apparatus 100 and the second file name notified from the transmitting apparatus 100 in step S3, a file. In this case, in the file generation unit 308, a file having a file name corresponding to the file name of the file to be recorded in the recording medium 106a is generated.

In step S5, an operation signal for ending the recording of the image data is input by the user via the operation unit 305 to the receiving apparatus 300. In this case, the CPU 301 controls the recording unit 304 to stop the process of recording the file generated by the file generation unit 308 in the recording medium 304a.

In step S6, the user inputs an operation signal for ending the recording of the image data to the transmitting apparatus 100 via the operation unit 108. In this case, the CPU 101 controls the recording unit 106 to stop the process of recording the file generated by the file generation unit 106b in the recording medium 106a. After the process, the image data generated by the imaging unit 104 and the image processing unit 105 is not recorded in the recording medium 106a.

In step S7, similar to the process in step S1, the CPU 1 transmits the first file name to the receiving apparatus 300. The process in step S7 is performed by the CPU 101 until an operation signal for starting recording is input to the transmitting apparatus 100 via the operation unit 108.

FIG. 4B illustrates an operation for using a file, generated based on image data transmitted from the transmitting apparatus 100, as a main image in the receiving apparatus 300 while using a file, recorded in the transmitting apparatus 100, as a proxy image. It is assumed that the file to be generated by the file generation unit 106b is recorded in the recording medium 106a.

The CPU 101 performs the process in step S11 when the data transmission unit 103b transmits image data to the receiving apparatus 300 via the TMDS line 202, and if image data generated by the imaging unit 104 and the image processing unit 105 is not recorded in the recording medium 106a. In step S11, similar to the process in step S1, the CPU 1 transmits the first file name to the receiving apparatus 300.

In step S12, an operation signal for starting recording of image data is input by the user to the receiving apparatus 300 via the operation unit 305. In this case, the CPU 301 controls the file generation unit 308 to generate, using the image data received by the communication unit 303 from the transmitting apparatus 100 and the first file name notified from the transmitting apparatus 100 in step S11, a file.

In step S13, the user inputs an operation signal for starting the recording of image data to the transmitting apparatus 100 via the operation unit 108. In this case, the CPU 101 controls the file generation unit 106b to generate a file including image data generated by the imaging unit 104 and the image processing unit 105. Further, in this case, the CPU 101 controls the recording unit 106 to record the generated file in the recording medium 106a. In step S14, the CPU 101 transmits the second file name to the receiving apparatus 300. In this case, the CPU 301 controls the file generation unit 308 to replace the file name included in the file generated in step S12 with the second file name notified from the transmitting apparatus 100 in step S14.

In step S15, the user inputs an operation signal for ending the recording of the image data to the transmitting apparatus 100 via the operation unit 108. In this case, the CPU 101 controls the recording unit 106 to stop the process of recording the file generated by the file generation unit 106b in the recording medium 106a. After the process, the image data generated by the imaging unit 104 and the image processing unit 105 is not recorded in the recording medium 106a.

In step S16, similar to the process in step S11, the CPU 101 transmits the first file name to the receiving apparatus 300. The process in step S16 is performed by the CPU 101 until an operation signal for starting recording of image data is input o the transmitting apparatus 100 via the operation unit 108.

In step S17, the user inputs an operation signal for ending the recording of the image data to the receiving apparatus 300 via the operation unit 305. In this case, the CPU 301 controls the recording unit 304 to stop the process of recording the file generated by the file generation unit 308 in the recording medium 304a.

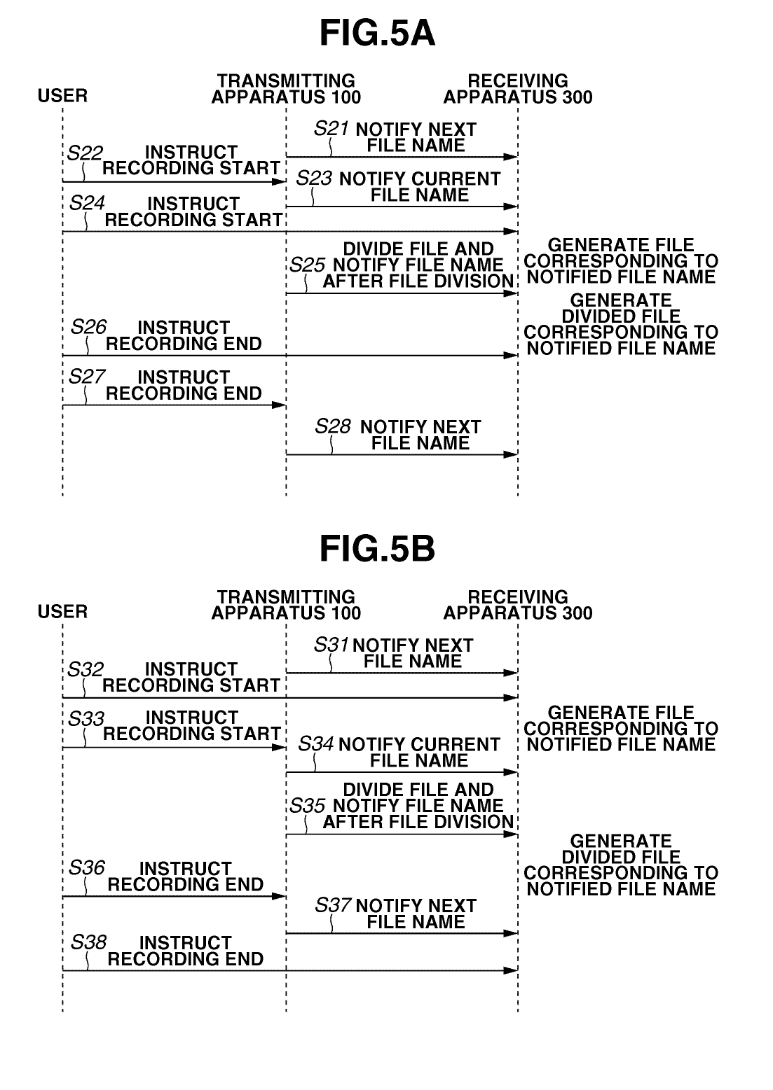

With reference of FIGS. 5A and 5B, a second operation performed by the transmitting apparatus 100 when a file name corresponding to a file divided by the transmitting apparatus 100 is notified to the receiving apparatus 300, and if a file generated by the transmitting apparatus 100 is divided, is described.

FIG. 5A illustrates an operation for using a file, generated based on image data transmitted from the transmitting apparatus 100, as a proxy image in the receiving apparatus 300 while using a file, recorded in the transmitting apparatus 100, as a main image is described. It is assumed that the file to be generated by the file generation unit 106b is recorded in the recording medium 106a. The process in steps S21 to S24 in FIG. 5A is similar to that in steps S1 to S4 described in FIG. 4A, and consequently, the description thereof is omitted. The process in steps S26 to S28 in FIG. 5A is similar to that in steps S5 to S7 described in FIG. 4A, and consequently, the description thereof is omitted. Hereinbelow, with reference to FIG. 5A, process different from that in FIG. 4A is described.

In step S22, if a data amount M of the file generated by the file generation unit 106b is greater than a predetermined value A, in step S25, the CPU 101 controls the file generation unit 106b to divide the file generated by the file generation unit 106b. In this case, the CPU 101 controls the file generation unit 106b to newly generate a file different from the file generated by the file generation unit 106b and recorded in the recording medium 106a in step S22. In this process, the CPU 101 transmits, to the receiving apparatus 300, a file name corresponding to the file newly generated by the file generation unit 106b and recorded in the recording medium 106a. The file name corresponding to the file newly generated by the file generation unit 106b and recorded in the recording medium 106a is referred to as “third file name”. Together with the third file name, status data of the image data to be transmitted to the receiving apparatus 300 may be transmitted to the receiving apparatus 300. Further, together with the third file name, data indicating that the file has been divided by the transmitting apparatus 100 may be transmitted to the receiving apparatus 300. When the third file name has been received by the receiving apparatus 300, the CPU 301 controls the file generation unit 308 to divide, using the image data received from the transmitting apparatus 100 and the third file name notified from the transmitting apparatus 100 in step S25, the file. In this case, in the file generation unit 308, a file having a file name corresponding to the file name of the file recorded in the recording medium 106a in step S25 is generated.

FIG. 5B illustrates an operation for using a file, generated based on image data transmitted from the transmitting apparatus 100, as a main image in the receiving apparatus 300 while using a file, recorded in the transmitting apparatus 100, as a proxy image is described. It is assumed that the file to be generated by the file generation unit 106b is recorded in the recording medium 106a. The process in steps S31 to S34 in FIG. 5B is similar to that in steps S11 to S14 described in FIG. 4B, and consequently, the description thereof is omitted. The process in steps S36 to S38 in FIG. 5B is similar to that in steps S15 to S17 described in FIG. 4B, and consequently, the description thereof is omitted. Hereinbelow, with reference to FIG. 5B, process different from that in FIG. 4B is described.

In step S33, if the data amount M of the file generated by the file generation unit 106b is greater than a predetermined value A, in step S35, the CPU 101 controls the file generation unit 106b to divide the file generated by the file generation unit 106b. In this case, the CPU 101 controls the file generation unit 106b to newly generate a file different from the file generated by the file generation unit 106b and recorded in the recording medium 106a in step S33. In this case, the CPU 101 transmits the third file name to the receiving apparatus 300. Further, if the third file name has been received by the receiving apparatus 300, the CPU 301 controls the file generation unit 308 to divide, using the image data received from the transmitting apparatus 100 and the third file name notified from the transmitting apparatus 100 in step S35, the file. In this case, in the file generation unit 308, a file having a file name corresponding to the file name of the file recorded in the recording medium 106a in step S35 is generated.

The receiving apparatus 300 generates, using the file name notified from the transmitting apparatus 100, the file including the image data received from the transmitting apparatus 100 if one of the first file name, the second file name, and the third file is received. However, in editing the image data received from the transmitting apparatus 100, the receiving apparatus 300 may generate a file including the image data received from the transmitting apparatus 100 using the file name notified from the transmitting apparatus 100. For this reason, until a file generation instruction is issued, the receiving apparatus 300 may prohibit the processing for generating a file including image data received from the transmitting apparatus 100 using a file name notified from the transmitting apparatus 100.

The transmitting apparatus 100 may, for example, use a <Vendor Command with ID> specified in the CEC protocol to transmit at least one of the first file name, the second file name, and the third file name to the receiving apparatus 300. The <Vendor Command with ID> is a command including a Vendor ID, and the command can be specified for each manufacturer. For example, when the transmitting apparatus 100 transmits the first file name to the receiving apparatus 300, the CPU 101 controls the command processing unit 103c to transmit a <Vendor Command with ID>, including data indicating the first file name, to the receiving apparatus 300. When the second file name or the third file name is transmitted to the receiving apparatus 300 using a <Vendor Command with ID>, the process is performed similarly to the case of the transmission of the first file name. Hereinbelow, the <Vendor Command with ID> is referred to as a “predetermined command”.

The transmitting apparatus 100 may use a Vendor-Specific InfoFrame specified in the HDMI standard to transmit at least one of the first file name, the second name, and the third file name to the receiving apparatus 300. The Vendor-Specific InfoFrame is additional data including a Vendor ID, and the additional data can be specified for each manufacturer. For example, when the transmitting apparatus 100 transmits the first file name to the receiving apparatus 300, the CPU 101 controls the data transmission unit 103b to transmit additional data, including data indicating the first file name, to the receiving apparatus 300. When the second file name or the third file name is transmitted to the receiving apparatus 300 using a Vendor-Specific InfoFrame, the process is performed similarly to the case of the transmission of the first file name. Hereinafter, the Vendor-Specific InfoFrame is referred to as a “predetermined additional data”.

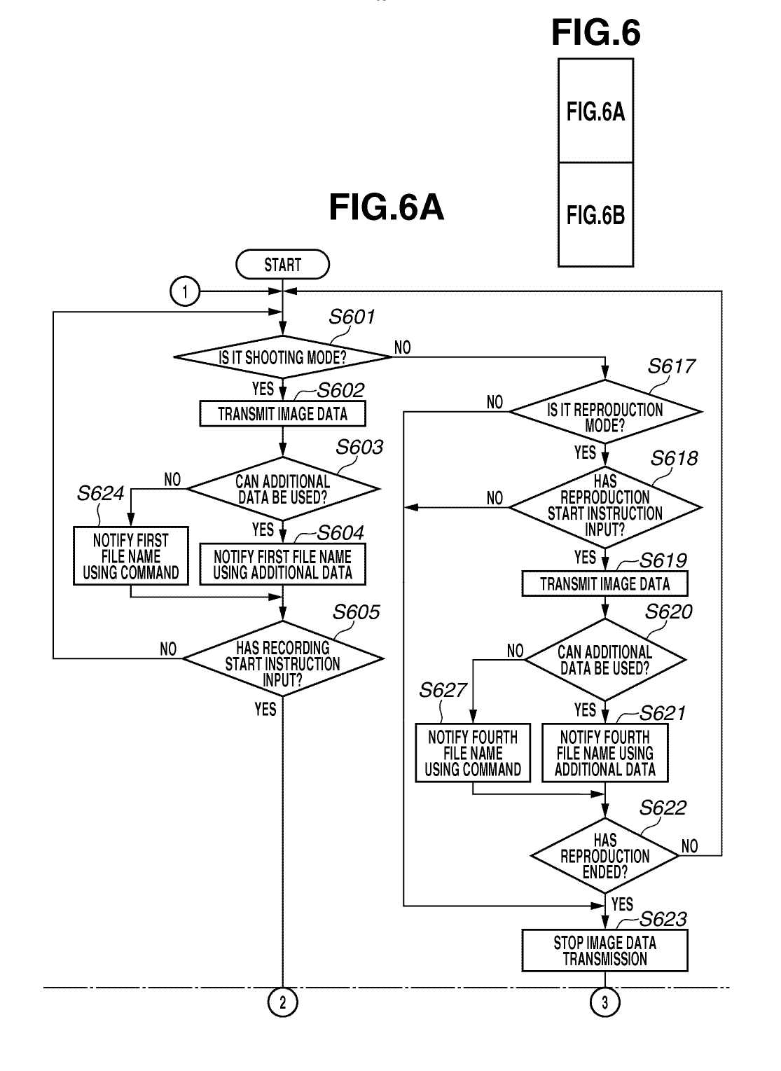

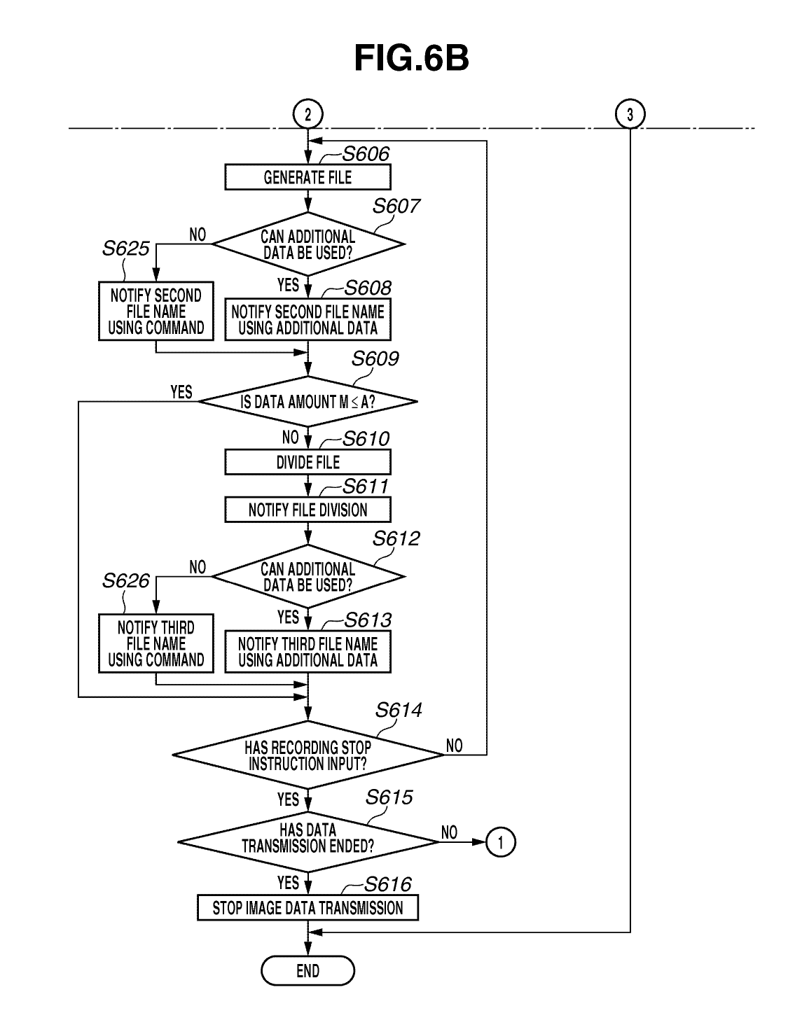

With reference to FIGS. 6A and 6B, notification process performed in the transmitting apparatus 100 according to the first exemplary embodiment is described. The notification process is performed when the transmitting apparatus 100 and the receiving apparatus 300 are connected via the connection cable 200. In the first exemplary embodiment, a case where the CPU 101 controls notification process according to a computer program stored in the memory 102 is described. The notification process in FIG. 6 is performed when the transmitting apparatus 100 has detected an HPD signal of the H level via an HPD line, and the transmitting apparatus 100 has acquired EDID from the receiving apparatus 300. The notification process in FIG. 6 is not performed when the transmitting apparatus 100 has not detected an HPD signal of the H level via the HPD line. The CPU 101 does not perform the notification process in FIG. 6 until the transmitting apparatus 100 receives EDID from the receiving apparatus 300 even if the transmitting apparatus 100 has detected an HPD signal of the H level via the HPD line if the transmitting apparatus 100 has not acquired EDID from the receiving apparatus 300.

In step S601, the CPU 101 determines whether the transmitting apparatus 100 is in the shooting mode. If the CPU 101 determines that the transmitting apparatus 100 is in the shooting mode (YES in step S601), the process proceeds from step S601 to S602. If the CPU 101 determines that the transmitting apparatus 100 is not in the shooting mode (NO in step S601), the process proceeds from step S601 to S617.

In step S602, the CPU 101 controls the data transmission unit 103b to transmit image data, generated by the imaging unit 104 and the image processing unit 105, to the receiving apparatus 300. In this case, the process proceeds from step S602 to S603.

In step S603, the CPU 101 determines whether the receiving apparatus 300 can use predetermined additional data. For example, using EDID acquired from the receiving apparatus 300, the CPU 101 may determine whether the receiving apparatus 300 can use predetermined additional data. Further, for example, to the receiving apparatus 300, the CPU 101 can transmit a command for checking whether the receiving apparatus 300 can use predetermined additional data. In this case, depending on a response from the receiving apparatus 300, the CPU 101 determines whether the receiving apparatus 300 can use predetermined additional data.

If the CPU 101 determines that the receiving apparatus 300 can use predetermined additional data (YES in step S603), the process proceeds from step S603 to S604. If the CPU 101 determines that the receiving apparatus 300 cannot use predetermined additional data (NO in step S603), the process proceeds from step S603 to S624.

In step S604, the CPU 101 generates predetermined additional data including data indicating the first file name. Further, the CPU 101 controls the data transmission unit 103b to transmit the generated predetermined additional data to the receiving apparatus 300 via the TMDS line 202. The first file name is, in step S604, transmitted to the receiving apparatus 300 together with the image data. In this case, the process proceeds from step S604 to S605.

In step S605, the CPU 101 determines whether an operation signal for starting recording of image data has input to the transmitting apparatus 100 via the operation unit 108. If the CPU 101 determines that an operation signal for starting recording of image data has input to the transmitting apparatus 100 via the operation unit 108 (YES in step S605), the process proceeds from step S605 to S606. If the CPU 101 determines that the operation signal for starting recording of image data has not input to the transmitting apparatus 100 via the operation unit 108 (NO in step S605), the process returns from step S605 to S601.

In step S606, the CPU 101 controls the file generation unit 106b to generate a file including image data generated by the imaging unit 104 and the image processing unit 105. Further, the CPU 101 controls the recording unit 106 to record the file generated by the file generation unit 106b in the recording medium 106a. The file generated by the file generation unit 106b in step S606 includes image data corresponding to the image data transmitted to the receiving apparatus 300 by the data transmission unit 103b. In this case, the process proceeds from step S606 to S607.

In step S607, similar to the process in step S603, the CPU 101 determines whether the receiving apparatus 300 can use the predetermined additional data. If the CPU 101 determines that the receiving apparatus 300 can use predetermined additional data (YES in step S607), the process proceeds from step S607 to S608. If the CPU 101 determines that the receiving apparatus 300 cannot use predetermined additional data (NO in step S607), the process proceeds from step S607 to S625.

In step S608, the CPU 101 generates predetermined additional data including data indicating the second file name. Further, the CPU 101 controls the data transmission unit 103b to transmit the generated predetermined additional data to the receiving apparatus 300 via the TMDS line 202. The second file name is, in step S608, transmitted to the receiving apparatus 300 together with the image data. In this case, the process proceeds from step S608 to S609.

In step S609, the CPU 101 determines whether a data amount M of the file generated by the file generation unit 106b is less than or equal to a predetermined value A. If the CPU 101 determines that data amount M of the file generated by the file generation unit 106b is less than or equal to the predetermined value A (YES in step S609), the process proceeds from step S609 to S614. If the CPU 101 determines that data amount M of the file generated by the file generation unit 106b is greater than the predetermined value A (NO in step S609), the process proceeds from step S609 to S610.

In step S610, the CPU 101 controls the file generation unit 106b to divide the generated file and generate a new file. In this case, the process proceeds from step S610 to S611. In step S610, the file, newly generated by the file generation unit 106b after a division of the file is performed, includes image data corresponding to the image data to be transmitted to the receiving apparatus 300 by the data transmission unit 103b.

In step S611, the CPU 101 notifies the receiving apparatus 300 that the file of the image data corresponding to the image data to be transmitted to the receiving apparatus 300 by the data transmission unit 103b has been divided. For example, the CPU 101 may control to generate additional data including data indicating that the file corresponding to the image data to be transmitted to the receiving apparatus 300 has been divided. Further, the CPU 202 may control the data transmission unit 103b to transmit the additional data, including data indicating that the file corresponding to the image data to be transmitted to the receiving apparatus 300 has been divided, together with the image data to the receiving apparatus 300. Further, for example, the CPU 101 may control to generate a command including data indicating that the file of the image data corresponding to the image data to be transmitted to the receiving apparatus 300 has been divided. Further, the CPU 101 may controls control the command processing unit 103c to transmit the command, including data indicating that the file of the image data corresponding to the image data to be transmitted to the receiving apparatus 300 has been divided, to the receiving apparatus 300. In this case, the process proceeds from step S611 to S612.

In step S612, similar to the process in step S603, the CPU 101 determines whether the receiving apparatus 300 can use the predetermined additional data. If the CPU 101 determines that the receiving apparatus 300 can use predetermined additional data (YES in step S612), the process proceeds from step S612 to S613. If the CPU 101 determines that the receiving apparatus 300 cannot use predetermined additional data (NO in step S612), the process proceeds from step S612 to S626.

In step S613, the CPU 101 generates predetermined additional data including data indicating the third file name. Further, the CPU 101 controls the data transmission unit 103b to transmit the generated predetermined additional data to the receiving apparatus 300 via the TMDS line 202. The third file name is, in step S613, transmitted to the receiving apparatus 300 together with the image data. In this case, the process proceeds from step S613 to S614.

In step S614, the CPU 101 determines whether an operation signal for stopping the recording of the image data has input o the transmitting apparatus 100 via the operation unit 108. If the CPU 101 determines that the operation signal for stopping the recording of the image data has input to the transmitting apparatus 100 via the operation unit 108 (YES in step S614), the process proceeds from step S614 to S615. If the CPU 101 determines that the operation signal for stopping the recording of the image data has not input to the transmitting apparatus 100 via the operation unit 108 (NO in step S614), the process returns from step S614 to S606.

In step S615, the CPU 101 determines whether an operation signal for stopping the transmission of the image data has input to the transmitting apparatus 100 via the operation unit 108. If the CPU 101 determines that the operation signal for stopping the transmission of the image data has input to the transmitting apparatus 100 via the operation unit 108 (YES in step S615), the process proceeds from step S615 to S616. If the CPU 101 determines that the operation signal for stopping the transmission of the image data has not input to the transmitting apparatus 100 via the operation unit 108 (NO in step S615), the process returns from step S615 to S601.

In step S616, the CPU 101 controls the imaging unit 104 and the image processing unit 105 to stop a generation of the image data, and controls the data transmission unit 103b to stop the transmission of the image data. In this case, the flowchart is terminated. In step S616, the CPU 101 may control the imaging unit 104 and the image processing unit 105 to stop the generation of the image data, and control the data transmission unit 103b not to stop the operation of the transmission of the image data.

In step S617, the CPU 101 determines whether the transmitting apparatus 100 is in the reproduction mode. If the CPU 101 determines that the transmitting apparatus 100 is in the reproduction mode (YES in step S617), the process proceeds from step S617 to S618. If the CPU 101 determines that the transmitting apparatus 100 is not in the reproduction mode (NO in step S617), the process proceeds from step S617 to S623.

In step S618, the CPU 101 determines whether an operation signal for starting reproduction of image data has input to the transmitting apparatus 100 via the operation unit 108. If the CPU 101 determines that the operation signal for starting reproduction of image data has input to the transmitting apparatus 100 via the operation unit 108 (YES in step S618), the process proceeds from step S618 to S619. If the CPU 101 determines that the operation signal for starting reproduction of image data has not input to the transmitting apparatus 100 via the operation unit 108 (NO in step S618), the process proceeds from step S618 to S623.

In step S619, the CPU 101 controls the recording unit 106 to read the image data included in the file instructed to be reproduced, and controls the data transmission unit 103b to transmit the read image data to the receiving apparatus 300. In this case, the process proceeds from step S619 to S620.

In step S620, the CPU 101 determines whether the receiving apparatus 300 can use predetermined additional data. If the CPU 101 determines that the receiving apparatus 300 can use predetermined additional data (YES in step S620), the process proceeds from step S620 to S621. If the CPU 101 determines that the receiving apparatus 300 cannot use predetermined additional data (NO in step S620), the process proceeds from step S620 to S627.

In step S621, the CPU 101 notifies the receiving apparatus 300 of a file name corresponding to the file being reproduced in step S619 using the predetermined additional data. The file name corresponding to the file being reproduced is referred to as “fourth file name”. In this case, the CPU 101 generates predetermined additional data including data indicating the fourth file name. Further, the CPU 101 controls the data transmission unit 103b to transmit the generated predetermined additional data to the receiving apparatus 300 via the TMDS line 202. The fourth file name is, in step S621, transmitted to the receiving apparatus 300 together with the image data. In this case, the process proceeds from step S621 to S622.

In step S622, the CPU 101 determines whether an operation signal for stopping the reproduction of the image data has input to the transmitting apparatus 100 via the operation unit 108. If the CPU 101 determines that the operation signal for stopping the reproduction of the image data has input to the transmitting apparatus 100 via the operation unit 108 (YES in step S622), the process proceeds from step S622 to S623. If the CPU 101 determines that the operation signal for stopping the reproduction of the image data has not input to the transmitting apparatus 100 via the operation unit 108 (NO in step S622), the process returns from step S622 to S601.

In step S623, the CPU 101 controls the recording unit 106 to stop the reproduction of the image data, and controls the data transmission unit 103b to stop the transmission of the image data. In this case, this flowchart is terminated. In step S623, the CPU 101 may control the recording unit 106 to stop the reproduction of the image data, and control the data transmission unit 103b not to stop the operation of the transmission of the image data.

In step S624, the CPU 101 generates a predetermined command including data indicating the first file name. Further, the CPU 101 controls the command processing unit 103c to transmit the generated predetermined command to the receiving apparatus 300 via the CEC line 203. In this case, the process proceeds from step S624 to S605.

In step S625, the CPU 101 generates a predetermined command including data indicating the second file name. Further, the CPU 101 controls the command processing unit 103c to transmit the generated predetermined command to the receiving apparatus 300 via the CEC line 203. In this case, the process proceeds from step S625 to S609.

In step S626, the CPU 101 generates a predetermined command including data indicating the third file name. Further, the CPU 101 controls the command processing unit 103c to transmit the generated predetermined command to the receiving apparatus 300 via the CEC line 203. In this case, the process proceeds from step S626 to S614.

In step S627, the CPU 101 notifies the receiving apparatus 300 of a file name corresponding to the file being reproduced in step S619 using the predetermined command. In this case, the CPU 101 generates a predetermined command including data indicating the fourth file name. Further, the CPU 101 controls the command processing unit 103c to transmit the generated predetermined command to the receiving apparatus 300 via the CEC line 203. In this case, the process proceeds from step S627 to S622.

In steps S603, S607, S612, and S620 in FIG. 6, the CPU 101 determines whether the receiving apparatus 300 can use predetermined additional data. By this process, depending on the determination result, the CPU 101 performs the control to notify the receiving apparatus 300 of a file name using predetermined additional data, or the control to notify the receiving apparatus 300 of a file name using a predetermined command. However, it is not limited thereto.

For example, in the process in steps S603, S607, S612, and S620, using predetermined additional data, the CPU 101 may determine whether the setting has been made to notify the receiving apparatus 300 of a file name. By this process, using the predetermined additional data, if the CPU 101 determines that the setting has been made to notify the receiving apparatus 300 of a file name, the CPU 101 notifies the receiving apparatus 300 of a file name using the predetermined additional data. In this case, using predetermined additional data, if the CPU 101 determines that the setting has not been made to notify the receiving apparatus 300 of a file name, the CPU 101 notifies the receiving apparatus 300 of a file name using a predetermined command.

Further, for example, in the process in steps S603, S607, S612, and S620, using a predetermined command, the CPU 101 may determine whether the setting has been made to notify the receiving apparatus 300 of a file name. By this process, using a predetermined command, if the CPU 101 determines that the setting has been made to notify the receiving apparatus 300 of a file name, the CPU 101 notifies the receiving apparatus 300 of a file name using the predetermined command. In this case, using a predetermined commend, if the CPU 101 determines that the setting has not been made to notify the receiving apparatus 300 of a file name, the CPU 101 notifies the receiving apparatus 300 of a file name using predetermined additional data.

In the notification process in FIG. 6, using predetermined additional data and a predetermined command, the transmitting apparatus 100 may transmit a file name to the receiving apparatus 300.

After the execution of the process in step S610, if the process in step S609 is performed again, the CPU 101 determines, after the file division, whether the data amount M of the file generated by the file generation unit 106b is less than or equal to the predetermined value A.

In one of the process in steps S621 and S627, the fourth file name is notified to the receiving apparatus 300. However, it may be configured in such a manner that when a request for notifying the fourth file name is issued from the receiving apparatus 300, the transmitting apparatus 100 performs one of the processes in steps S621 and S627 to notify the fourth file name to the receiving apparatus 300. In such a case, it may be configured in such a manner that if a request for notifying the fourth file name is not issued from the receiving apparatus 300, the transmitting apparatus 100 does not notify the fourth file name to the receiving apparatus 300. Further, if the transmitting apparatus 100 detects that the receiving apparatus 300 has recorded the reproduction image data transmitted to the receiving apparatus 300 in step S619, the transmitting apparatus 100 may notify the fourth file name to the receiving apparatus 300 by performing the process of step S621 or the process of S627. Further, if the transmitting apparatus 100 detects that the receiving apparatus 300 has not recorded the reproduction data transmitted to the receiving apparatus 300 in step S619, it may be configured in such a manner that the transmitting apparatus 100 does not notify the fourth file name to the receiving apparatus 300.

In the transmitting apparatus 100 according to the first exemplary embodiment, when the transmitting apparatus 100 transmits image data to the receiving apparatus 300, to notify a file name relating to the image data to be transmitted to the receiving apparatus 300, the notification process in FIG. 6 is performed. However, it is not limited thereto. For example, the notification process in FIG. 6 may be performed when the transmitting apparatus 100 transmits image data and audio data to the receiving apparatus 300. Further, for example, the notification process in FIG. 6 may be performed when the transmitting apparatus 100 does not transmit image data to the receiving apparatus 300, but the transmitting apparatus 100 transmits audio data to the receiving apparatus 300.

In the transmitting apparatus 100 according to the first exemplary embodiment, the resolution of the image data to be transmitted from the transmitting apparatus 100 to the receiving apparatus 300 may be, for example, 3840 in the number of horizontal pixels and 2160 in the number of vertical pixels. In the transmitting apparatus 100 according to the first exemplary embodiment, the resolution of the image data to be transmitted from the transmitting apparatus 100 to the receiving apparatus 300 may be, for example, 4096 in the number of horizontal pixels and 2160 in the number of vertical pixels. In the transmitting apparatus 100 according to the first exemplary embodiment, the resolution of the image data to be transmitted from the transmitting apparatus 100 to the receiving apparatus 300 can be a resolution other than the above-mentioned resolutions.

As described above, in the first exemplary embodiment, when the transmitting apparatus 100 transmits image data to the receiving apparatus 300, the transmitting apparatus 100 notifies a file name relating to the image data to be transmitted to the receiving apparatus 300. By this process, even if the receiving apparatus 300 cannot specify a file name of a file including image data received from the transmitting apparatus 100 due to specific specifications, to the receiving apparatus 300, the transmitting apparatus 100 can specify the file name of the file to be recorded in the receiving apparatus 100. In this case, the receiving apparatus 300 can generate a file corresponding to the file name of the file to be recorded in the transmitting apparatus 100, associate the generated file with the file generated in the transmitting apparatus 100, and manage the files

Consequently, for example, when image data received from the transmitting apparatus 100 by the receiving apparatus 300 is edited, the relationship between the file generated in the receiving apparatus 300 and the file recorded in the transmitting apparatus 100 can be readily understood. As a result, the user can appropriately edit the image data. Further, when image data is edited, the transmitting apparatus 100 can use the file recorded in the transmitting apparatus 100 as a main image while using the file generated in the receiving apparatus 300 as a proxy image. Further, when image data is edited, the transmitting apparatus 100 can use the file recorded in the transmitting apparatus 100 as a proxy image while using the file generated in the receiving apparatus 300 as a main image.

Consequently, when the transmitting apparatus 100 transmits image data to the receiving apparatus 300, the receiving apparatus 300 can appropriately manage the image data by notifying the receiving apparatus 300 of data about image data before the transmission to the receiving apparatus 300.

In the first exemplary embodiment, using a <Vendor Command with ID>, at least one of the first file name, the second file name, the third file name, and the fourth file name is transmitted to the receiving apparatus 300. In the first exemplary embodiment, using a Vendor-Specific InfoFrame, at least one of the first file name, the second name, the third file name, and the fourth file name is transmitted to the receiving apparatus 300. However, it is not limited thereto.

For example, the transmitting apparatus 100 can use an HDMI Ethernet (registered trademark) Channel (HEC) complying with the HDMI standard to transmit at least one of the first file name, the second file name, the third file name, and the fourth file name to the receiving apparatus 300. In this case, through Ethernet (registered trademark), at least one of the first file name, the second file name, the third file name, and the fourth file name is transmitted from the transmitting apparatus 100 to the receiving apparatus 300.

The transmitting apparatus 100 according to the first exemplary embodiment transmits image data and a file name to the receiving apparatus 300 through communications complying with the HDMI standard, however, it is not limited thereto.

For example, the transmitting apparatus 100 may transmit image data and a file name to the receiving apparatus 300 through communications compatible with standards complying with the HDMI standard.

For example, the transmitting apparatus 100 may transmit image data and a file name to the receiving apparatus 300 through communications complying with the Digital Visual Interface (DVI) (registered trademark) standard.

Further, for example, the transmitting apparatus 100 may transmit image data and a file name to the receiving apparatus 300 through communications complying with the Display Port (registered trademark) standard.

Further, for example, the transmitting apparatus 100 may transmit image data and a file name to the receiving apparatus 300 through communications complying with the Digital Interface for Video and Audio (DiiVa).

Further, for example, the transmitting apparatus 100 may transmit image data and a file name to the receiving apparatus 300 through communications complying with the Mobile High-definition Link (MHL) (registered trademark) standard.

Further, for example, the transmitting apparatus 100 may transmit image data and a file name to the receiving apparatus 300 through communications complying with the Universal Serial Bus (USB) standard.

Further, for example, the transmitting apparatus 100 may transmit image data and a file name to the receiving apparatus 300 through communications complying with the Serial Digital Interface (SDI) standard.

Further, for example, the transmitting apparatus 100 may transmit image data and a file name to the receiving apparatus 300 according to the Wireless HD (registered trademark) standard.

Further, for example, the transmitting apparatus 100 may transmit image data and a file name to the receiving apparatus 300 according to the Wireless Home Digital Interface (WHDI) standard.

The transmitting apparatus 100 is configured to transmit, together with image data, a file name relating to the image data to the receiving apparatus 300. However, in place of the file name of the file relating to the image data to be transmitted to the receiving apparatus 300, the transmitting apparatus 100 can transmit to the receiving apparatus 300 identification data for identifying the file relating to the image data to be transmitted to the receiving apparatus 300. In this case, in place of the first file name, the transmitting apparatus 100 may transmit to the receiving apparatus 300 identification data for identifying a file expected to be recorded by the transmitting apparatus 100. In this case, in place of the second file name, the transmitting apparatus 100 may transmit to the receiving apparatus 300 identification data for identifying a file to be recorded in the recording medium 106a. In this case, in place of the third file name, the transmitting apparatus 100 may transmit to the receiving apparatus 300 identification data for identifying a file, which is newly generated by the file generation unit 106b after execution of file division, to be recorded in the recording medium 106a. In this case, in place of the fourth file name, the transmitting apparatus 100 may transmit to the receiving apparatus 300 identification data for identifying a file being reproduced.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-114615 filed May 18, 2012, which is hereby incorporated by reference herein in its entirety.

What is claimed is:

1. A transmitting apparatus comprising:
a generating unit that generates image data;
a storing unit that stores a file including image data generated by the generating unit in a storage medium after a recording instruction is input to the transmitting apparatus;
a transmitting unit that transmits image data to a receiving apparatus; and
a control unit that performs a process for transmitting, to the receiving apparatus, data for identifying a file relating to image data to be transmitted to the receiving apparatus.

2. The transmitting apparatus according to claim 1,
wherein the control unit performs a process for transmitting, to the receiving apparatus, data for identifying a file relating to image data to be stored in the storage medium if the recording instruction is not input to the transmitting apparatus, and
wherein the transmitting unit transmits generated image data to the receiving apparatus.

3. The transmitting apparatus according to claim 1,
wherein the control unit performs a process for transmitting, to the receiving apparatus, data for identifying a file relating to image data stored in the storage medium after the recording instruction is input to the transmitting apparatus, and
wherein the transmitting unit transmits generated image data to the receiving apparatus.

4. The transmitting apparatus according to claim 1,
wherein the control unit performs a process for generating a new file if a data amount of a file to be stored in the storing medium is greater than a predetermined value, and the control unit performs a process for transmitting, to the receiving apparatus, data for identifying the new file after the process is performed, and
wherein the transmission unit transmits generated image data to the receiving apparatus.

5. The transmitting apparatus according to claim 1, further comprising a reproduction unit that reproduces image data from the recording medium,
wherein the control unit performs a process for transmitting, to the receiving apparatus, data for identifying a file relating to image data reproduced from the recording medium after a reproduction instruction is input to the transmitting apparatus, and
wherein the transmitting unit transmits image data reproduced from the recording medium to the receiving apparatus.

6. The transmitting apparatus according to claim 1, wherein the control unit controls the transmitting unit to transmit, to the receiving apparatus, predetermined additional data and image data, and
wherein the predetermined additional data includes data for identifying a file relating to image data to be transmitted to the receiving apparatus.

7. The transmitting apparatus according to claim 1, wherein the transmitting unit transmits, based on the HDMI standard, data for identifying a file relating to image data to be transmitted to the receiving apparatus to the receiving apparatus.

8. A method comprising:
generating image data;
storing a file including generated image data in a storage medium in response to a recording instruction;
transmitting image data to a receiving apparatus; and
transmitting, to the receiving apparatus, data for identifying a file relating to image data to be transmitted to the receiving apparatus.

9. A non-transitory computer-readable storage medium that stores a program for causing a computer to execute a method, the method comprising
generating image data;
storing a file including generated image data in a storage medium in response to a recording instruction;
transmitting the image data to a receiving apparatus; and
transmitting, to the receiving apparatus, data for identifying a file relating to image data to be transmitted to the receiving apparatus.
